(19) United States
(12) Patent Application Publication
(10) Pub. No.: US 2016/0047305 A1
(43) Pub. Date: Feb. 18, 2016

(54) MULTI-STAGE AXIAL COMPRESSOR ARRANGEMENT

(71) Applicant: General Electric Company, Schenectady, NY (US)

(72) Inventors: Thomas Edward Wickert, Greenville, SC (US); Dwight Eric Davidson, Greer, SC (US)

(21) Appl. No.: 14/460,560

(22) Filed: Aug. 15, 2014

(51) Int. Cl. F02C 3/107; F02C 7/36; F04D 19/02

(52) U.S. Cl. CPC F02C 3/107; F04D 19/02; F02C 7/36; F05D 2260/40311

(57) ABSTRACT

A multi-stage axial compressor arrangement is disclosed that uses a compressor speed reducer to rotate the moving blades in the forward stages of the compressor at a slower rotational speed than the moving blades in the mid stages and the aft stages of the compressor. Slowing the rotational speed of the moving blades in the forward stages in relation to the blades in the mid stages and the aft stages, enables the multi-stage axial compressor to deliver a high airflow rate while overcoming excessive attachment stresses that is typically experienced in the large rotating blades of the forward stages of the compressor.

### CROSS REFERENCE TO RELATED APPLICATIONS

This patent application relates to the following commonly-assigned patent applications: U.S. patent application Ser. No. _____, entitled “POWER GENERATION ARCHITECTURES WITH MONO-TYPE LOW-LOSS BEARINGS AND LOW-DENSITY MATERIALS”, Attorney Docket No. 261580-1 (GEEN-481); U.S. patent application Ser. No. ______, entitled “POWER GENERATION ARCHITECTURES WITH HYBRID-TYPE LOW-LOSS BEARINGS AND LOW-DENSITY MATERIALS”, Attorney Docket No. 267305-1 (GEEN-480); U.S. patent application Ser. No. ______, entitled “MECHANICAL DRIVE ARCHITECTURES WITH MONO-TYPE LOW-LOSS BEARINGS AND LOW-DENSITY MATERIALS”, Attorney Docket No. 271508-1 (GEEN-0539); U.S. patent application Ser. No. ______, entitled “MECHANICAL DRIVE ARCHITECTURES WITH HYBRID-TYPE LOW-LOSS BEARINGS AND LOW-DENSITY MATERIALS”, Attorney Docket No. 271509-1 (GEEN-0540); U.S. patent application Ser. No. ______, entitled “POWER TRAIN ARCHITECTURES WITH LOW-LOSS LUBRICANT BEARINGS AND LOW-DENSITY MATERIALS”, Attorney Docket No. 276988; and U.S. patent application Ser. No. ______, entitled “MECHANICAL DRIVE ARCHITECTURES WITH LOW-LOSS LUBRICANT BEARINGS AND LOW-DENSITY MATERIALS”, Attorney Docket No. 276989. Each patent application identified above is filed concurrently with this application and incorporated herein by reference.

### BACKGROUND OF THE INVENTION

The present invention relates generally to turbomachinery, and more particularly, to a multi-stage axial compressor arrangement that is configured to slow the rotational speed of rotating blades in the forward stages of a compressor in relation to the mid and aft stages of the compressor.

Typically, the rotating blades in the forward stages of a multi-stage axial compressor are larger than the rotating blades in both the mid and aft stages of the compressor. This makes the larger rotating blades in the forward stages of an axial compressor more susceptible to being highly stressed during operation due to large centrifugal loads applied by the rotation of longer and heavier blades. In particular, large centrifugal loads are placed on the blades in the forward stages of the axial compressor due to the high rotational speed of the rotor wheels, which in turn, stress the blades, making them subject to large attachment stresses. The large attachment stresses that can arise on the rotating blades in the forward stages of an axial compressor become problematic as it becomes more desirable to increase the size of the blades to produce a compressor that can generate a higher airflow rate as demanded by certain applications. Typically, rotating blades in an axial compressor are made from steel, but these types of blades are reaching their AN² limit (i.e., the product of the annulus area (in²) and rotational speed squared (rpm²)—a parameter that generally quantifies attachment stress on a blade) as compressor manufacturers seek to increase the size of the blades.

### BRIEF DESCRIPTION OF THE INVENTION

In one aspect of the present invention, a multi-stage axial compressor is disclosed. In this aspect of the present invention, the multi-stage axial compressor comprises a rotatable shaft having rotating blades arranged in a circumferential array to define a plurality of moving blade rows each extending radially outward from the rotatable shaft. A casing surrounds the rotatable shaft. The casing has a plurality of annular rows of stationary vanes each extending radially inward towards the rotatable shaft. The annular rows of stationary vanes are arranged with the plurality of moving blade rows in an alternating pattern along an axial direction parallel with an axis of rotation of the rotatable shaft. Each moving blade row immediately followed by a row of stationary vanes forms a stage in the axial direction. The alternating pattern of a moving blade row immediately followed by a row of stationary vanes defines forward stages at one end of the axial direction and aft stages at an opposing end, with mid stages disposed therebetween. A compressor speed reducer is configured to rotate the moving blades in the forward stages at a slower rotational speed than the moving blades in the mid stages and the aft stages.

In a second aspect of the present invention, a gas turbine engine and generator arrangement is disclosed. In this aspect of the present invention, the gas turbine engine and generator arrangement comprises a turbine, a generator, and a compressor in cooperative operation with the turbine and the generator. The compressor has a rotatable shaft with a plurality of moving blade rows each extending radially outward from the rotatable shaft. A plurality of annular rows of stationary vanes with each extending radially inward towards the rotatable shaft. The annular rows of stationary vanes are arranged with the plurality of moving blade rows in an alternating pattern along an axial direction parallel with an axis of rotation of the rotatable shaft. Each moving blade row immediately followed by a row of stationary vanes forms a stage in the axial direction. The alternating pattern of a moving blade row immediately followed by a row of stationary vanes defines forward stages at one end of the axial direction and aft stages at an opposing end, with mid stages disposed therebetween. A compressor speed reducer is configured to rotate the moving blades in the forward stages at a slower rotational speed than the moving blades in the mid stages and the aft stages.

In a third aspect of the present invention, a method is disclosed. In this aspect of the present invention, the method comprises configuring a compressor speed reducer with a compressor having a rotatable shaft with a plurality of moving blade rows each extending radially outward from the rotatable shaft. A plurality of annular rows of stationary vanes with each extending radially inward towards the rotatable shaft. The annular rows of stationary vanes are arranged with the plurality of moving blade rows in an alternating pattern along an axial direction parallel with an axis of rotation of the rotatable shaft. Each moving blade row immediately followed by a row of stationary vanes forms a stage in the axial direction. The alternating pattern of a moving blade row immediately followed by a row of stationary vanes defines forward stages at one end of the axial direction and aft stages at an opposing end, with mid stages disposed therebetween. The method further comprises using the compressor speed reducer to rotate the moving blades in the forward stages of the compressor at a slower rotational speed than the moving blades in the mid stages and the aft stages of the compressor.

### BRIEF DESCRIPTION OF THE DRAWINGS

FIG. 1 is a schematic diagram of a multi-stage axial compressor having a compressor speed reducer according to an embodiment of the present invention;

FIG. 2 is a schematic diagram of a multi-stage axial compressor having a gearing and bearing arrangement as the compressor speed reducer according to an embodiment of the present invention;

FIGS. 3A-3B are schematic diagrams of a multi-stage axial compressor having a torque converter as the compressor speed reducer according to an embodiment of the present invention; and

FIGS. 4A-4C are schematic diagrams of a multi-stage axial compressor having a motor as the compressor speed reducer according to an embodiment of the present invention.

### DETAILED DESCRIPTION OF THE INVENTION

Various embodiments of the present invention are directed to slowing the rotational speed of the rotating blades in the forward stages of a multi-stage axial compressor in relation to the mid and aft stages of the compressor. The various embodiments of the present invention as described herein can utilize a compressor speed reducer to slow the rotational speed of the rotating blades in the forward stages of a multi-stage axial compressor. In one embodiment, the compressor speed reducer can include a fixed-axis gear system that couples the moving blades in the forward stages to the compressor's rotatable shaft. In one embodiment, the compressor speed reducer can include a torque converter that couples the moving blades in the forward stages to the rotatable shaft. In one embodiment, the compressor speed reducer can include an electric motor that drives the moving blades in the forward stages at a slower rotation speed. In one embodiment, the compressor speed reducer can include a magnetic motor that drives the moving blades in the forward stages at a slower rotation speed. The magnetic motor can be radially aligned with the moving blades in the forward stages. The magnetic motor can also be axially aligned with the rotatable shaft at a location proximate the moving blades in the forward stages. In one embodiment, a bearing arrangement can be configured to support the compressor speed reducer in relation to the rotatable shaft and the moving blades in the forward stages. This bearing arrangement can include film-type (e.g., oil, gas, water or steam), rolling-element (e.g., ball, needle, cylindrical, tapered, spherical or elliptical roller) or magnetic bearing arrangements.

The technical effects of the various embodiments of the present invention include providing an axial compressor that can be configured to deliver a larger quantity of airflow which translates to a higher output of the compressor or the gas turbine engine if used in such a setting. The larger quantity of airflow and output that results from the multi-stage axial compressor arrangement can be attained by using conventional blading material (e.g., steel). As a result, compressor manufacturers can continue increasing the size of the rotating blades in the compressor to generate higher airflow rates, while at the same time ensuring that such increased blades keep with prescribed AN² limits to obviate excessive attachment stresses.

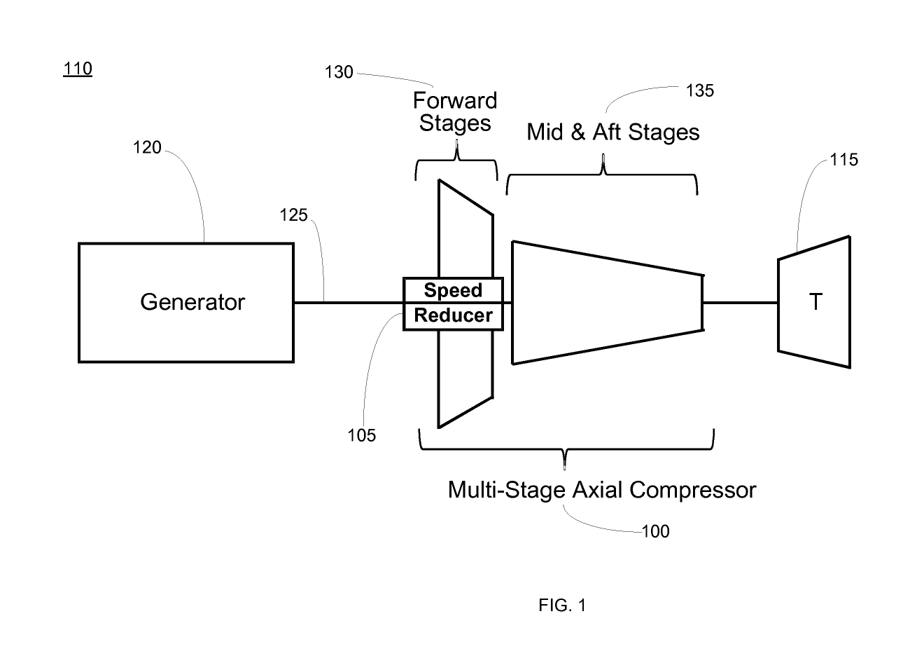

Referring now to the figures, FIG. 1 shows a schematic diagram of a multi-stage axial compressor 100 having a compressor speed reducer 105 operating within a gas turbine engine and generator arrangement 110. Although the multi-stage axial compressor arrangement with compressor speed reducer is described herein with respect to a gas turbine engine and generator arrangement, the various embodiments of the present invention are not meant to be limited to use solely as a compressor component with a gas turbine engine and generator arrangement. Instead, the multi-stage axial compressor arrangement with compressor speed reducer can have a multitude of applications. In one embodiment, the multi-stage axial compressor arrangement can be a stand-alone compressor. In another embodiment, the multi-stage axial compressor arrangement with compressor speed reducer can be used as a multi-stage axial/centrifugal compressor either as a compressor component of a gas turbine engine, a gas turbine engine and generator arrangement or as a stand-alone compressor.

Referring back to FIG. 1, multi-stage axial compressor 100 is situated between a turbine section 115 and a generator 120. In one embodiment, a common rotatable shaft 125 couples multi-stage axial compressor 100, turbine section 115 and generator 120 along a single line. In this configuration, turbine section 115 can drive multi-stage axial compressor 100 and generator 120. Although multi-stage axial compressor 100, turbine section 115 and generator 120 are coupled by a single common rotatable shaft 125, those skilled in the art will appreciate that other coupling and shaft line arrangements may be used. For example, multi-shaft configurations using other coupling and shaft line arrangements are with the scope of the various embodiments of the present invention.

In addition, those skilled in the art will appreciate that for clarity, gas turbine engine and generator arrangement 110 is shown in FIG. 1 with the components that illustrate the various embodiments of the present invention and that there would be other components than what is shown in this figure. For example, gas turbine engine and generator arrangement 110 could have a combustor chamber section as one of the other primary components, and secondary components such as a gas fuel skid, flow control valves, a cooling system, etc. Furthermore, gas turbine engine and generator arrangement 110 as illustrated in FIG. 1 is only one example of a configuration in which the various embodiments of the present embodiment can operate and is not intended to be limiting.

In FIG. 1, multi-stage axial compressor 100 can include stages of blades disposed in an axial direction along the rotatable shaft 125. In particular, multi-axial compressor 100 includes forward stages of blades 130 and mid and aft stages of blades 135. As used herein, the forward stages of blades 130 are situated at the front or forward end of multi-stage axial compressor 100 along rotatable shaft 125 at the portion where airflow (or gas flow) enters the compressor via inlet guide vanes (not shown). The mid and aft stages of blades 135 refers to the blades disposed downstream of the forward stages along rotatable shaft 125 where the airflow (or gas flow) is further compressed to an increased pressure.

Each of the stages can include rotating blades arranged in a circumferential array about the circumference of the rotatable shaft 125 to define moving blade rows extending radially outward from the rotatable shaft. The moving blade rows are disposed axially along the rotatable shaft 125 in locations that are situated in the forward stages 130 and the mid and aft stages 135. In addition, each of the stages can include annular rows of stationary vanes extending radially inward towards the rotatable shaft 125 in the forward stages 130 and the mid and aft stages 135. In one embodiment, the annular rows of stationary vanes can be disposed on the compressor's casing (not illustrated) that surrounds the rotatable shaft 125. In each of the stages, the annular rows of stationary vanes can be arranged with the moving blade rows in an alternating pattern along an axial direction of the rotatable shaft 125 parallel with its axis of rotation. In this manner, the moving blades in each stage are chambered to apply work and to turn the flow toward the axial direction, while the stationary vanes in each stage are chambered to turn the flow toward the axial direction, preparing it for the moving blades of the next stage.

Compressor speed reducer 105 which is disposed about the forward stages of blades 130 is configured to rotate the moving blades in these stages at a slower rotational speed than the moving blades in the mid and aft stages 135. In one embodiment, compressor speed reducer 105 can slow the rotational speed of the moving blades from any one stage or combinations of stages starting from the first stage up to the fifth stage as defined from the forward end of the multi-stage compressor where airflow (or gas flow) enters the compressor. The amount of stages that form the forward stages of blades 130 can vary depending on the amount of total stages in a compressor. Furthermore, the amount of stages that form the forward stages of blades 130 in the various embodiments of the present invention which are directed to reducing the rotational speed of the moving blades is not meant to be limited to any particular stage number. Those skilled in the art will appreciate that the designation of forward stages of blades is meant to refer generally to the stages of the compressor that contribute to the compressor flow rate, while the designation of the mid and aft stages of blades is meant to refer generally to the stages of the compressor that contribute its pressure rise.

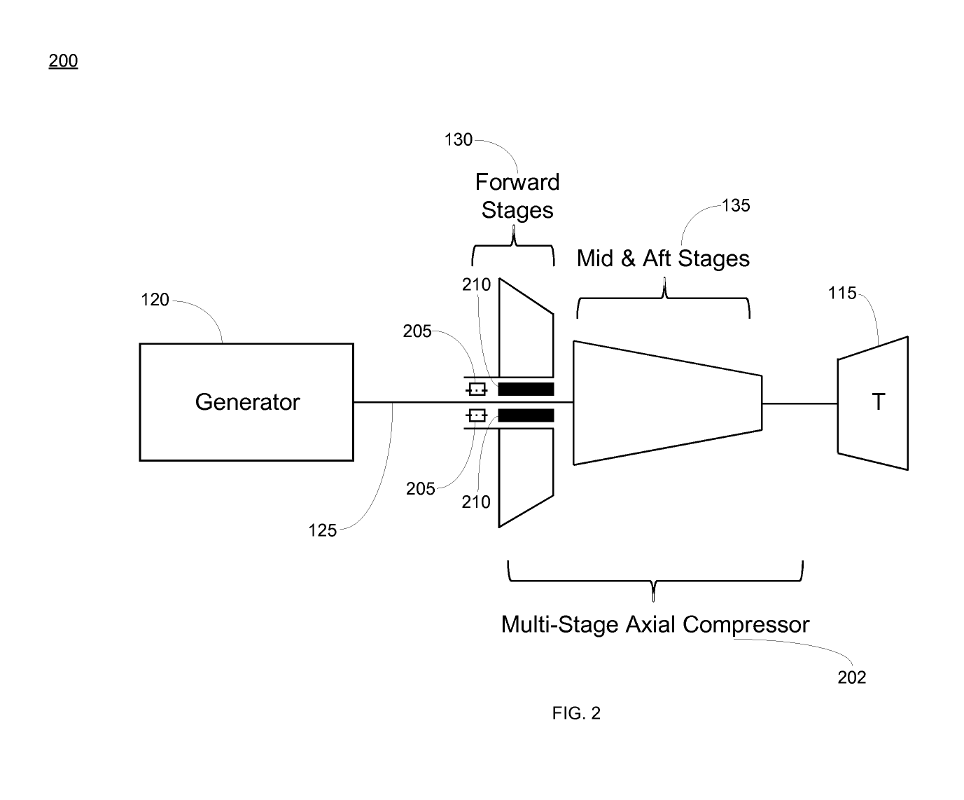

In one embodiment, compressor speed reducer 105 can slow the rotational speed of the moving blades in the forward stages in a manner such that the blades in these stages rotate in more than one direction. For example, compressor speed reducer 105 can slow the rotational speed of the moving blades in the forward stages 130 in a direction that is similar to the direction of the rotation of the blades in the mid and aft stages 135. Likewise, in another embodiment, compressor speed reducer 105 can slow the rotational speed of the moving blades in the forward stages 130 in a direction that is opposite to the direction of rotation of the blades in the mid and aft stages 135. Examples of the various implementations for compressor speed reducer 105 that can slow down the rotational speed of the moving blades in the forward stages of the multi-stage axial compressor 100 are described below in more detail and with reference to FIGS. 2-5.

Gas turbine engine and generator arrangement 110 in use with the multi-stage axial compressor 100 and compressor speed reducer 105 can operate in the following manner. As air is directed to multi-stage axial compressor 100 through inlet guide vanes, compressor speed reducer can be configured to slow down the rotational speed of the forward stages of blades 130 in relation to the mid and aft stages of blades 135. For example, compressor speed reducer 105 can be used to slow down the speed of the forward stages of blades 130 to approximately 3000 revolutions per minute (RPMs) while the moving blades of the mid and aft stages of blades 135 rotate at approximately 3600 RPMs. Slowing down the rotational speed of the forward stages of blades 130 in relation to the mid and aft stages of blades 135 will allow for larger forward stages delivering an increased airflow (or gas flow) through compressor 100, which means that more airflow will flow through gas turbine engine 110. More airflow through gas turbine engine 110 translates to more output. This can be achieved by using conventional steel blades and not blades constructed from low-density materials such as titanium (e.g., solid titanium and hollow-core titanium) or composites. Because the moving blades of the forward stages can operate at a reduced speed, attachment stresses that typically arise in these stages can be mitigated. This allows compressor manufacturers to grow the sizes of the moving blades of the forward stages to sizes that are within prescribed AN² limits.

Continuing with the description of the operation of gas turbine engine and generator arrangement 110, the compressed air from multi-stage axial compressor 100 is mixed with fuel in a combustor chamber section (not illustrated in FIG. 1). Turbine section 115 is rotatably driven by a high-temperature combustion gas generated from the combustor chamber section. The combustion gas can be discharged from gas turbine engine and generator arrangement 110 as an exhaust gas. Generator 120 is driven by a rotating power of turbine section 115 which is transmitted through rotatable shaft 125 that operates cooperatively with multi-stage axial compressor 100 and turbine section 115. In this manner, compressor speed reducer 105 would not change the rotational speed of shaft 125 at a portion that couples to turbine section 115. That is, the rotational speed of shaft 125 at the portion that couples with turbine section 115 will not increase or decrease.

FIG. 2 is a schematic diagram of a gas turbine engine and generator arrangement 200 with a multi-stage axial compressor 202 having a gearing arrangement 205 and a bearing arrangement 210 as the compressor speed reducer. Gearing arrangement 205 and bearing arrangement 210 can be located about the forward stages of blades 130 on or proximate rotatable shaft 125. In this manner, gearing arrangement 205 and bearing arrangement 210 can slow the rotational speed of the moving blades in the forward stages of blades 130. Gearing arrangement 205 can be configured in several different forms. In one embodiment, gearing arrangement 205 can be a fixed-axis gear system that couples the moving blades in the forward stages 130 to the rotatable shaft 125. In another embodiment, gearing arrangement 205 can be a planetary gear system that couples the moving blades in the forward stages 130 to the rotatable shaft 125. Bearing arrangement 210 can be configured in several different forms to support gearing arrangement 205 in relation to rotatable shaft 125 and the moving blades in the forward stage 130. In one embodiment, bearing arrangement 210 can include film-type (e.g., oil, gas, water or steam) bearings. In another embodiment, bearing arrangement 210 can include rolling-element (e.g., ball, needle, cylindrical, tapered, spherical or elliptical roller) bearings. In another embodiment, bearing arrangement 210 can include magnetic bearings.

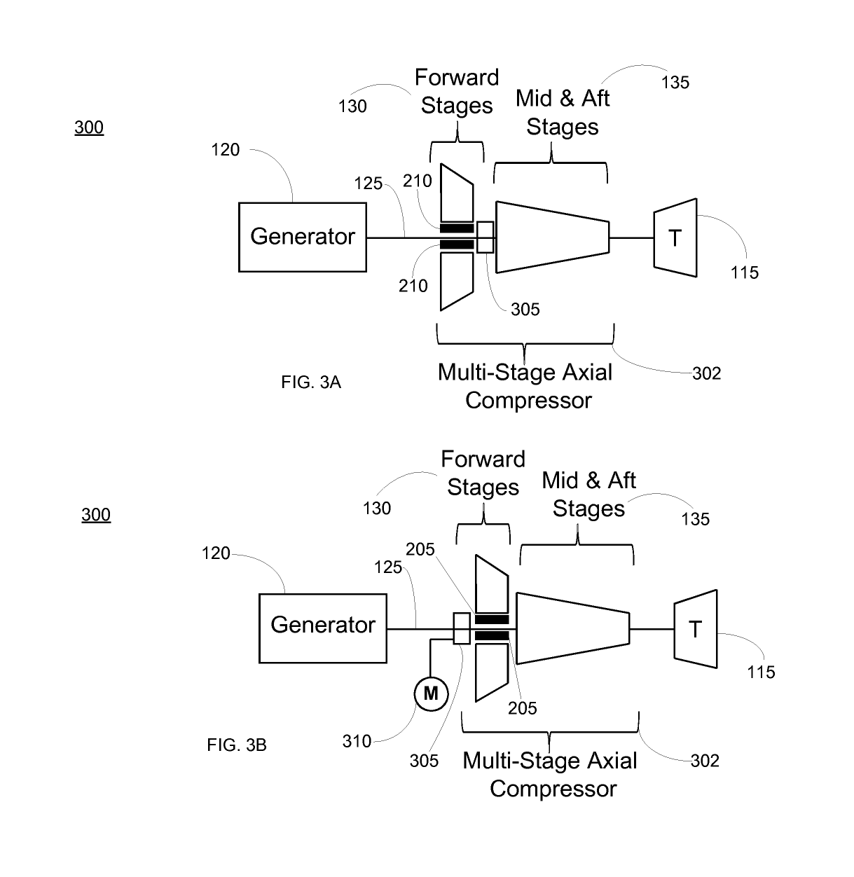

FIGS. 3A-3B are schematic diagrams of a gas turbine engine and generator arrangement 300 with a multi-stage axial compressor 302 having a torque converter 305 as the compressor speed reducer according to an embodiment of the present invention. In FIG. 3A, torque converter 305 can be located adjacent the forward stages of blades 130 on or proximate rotatable shaft 125. In one embodiment, as shown in FIG. 3A, torque converter 305 is located about rotatable shaft 125 between the forward stages of blades 130 and the mid and aft stages of blades 135. In this manner, torque converter 305 creates a fluid coupling between the moving blades in the forward stages of blades 130 and the shaft 125 in the mid and aft stages 135. The torque converter 305 allows rotating power to be transferred via re-circulating fluid in a closed housing allowing a rotational speed reduction between the forward stages of blades 130 and the shaft 125 in the mid and aft stages 135. In FIG. 3B, torque converter 305 operates in conjunction with a motor 310 to control the rotational speed of the moving blades in the forward stages of blades 130 while the shaft 125 in the mid and aft stages 135 continues to rotate the blades in these stages at its typical rotational speed. Torque converter 305 as used in FIGS. 3A-3B can include a low-viscosity compact torque converter that couples the moving blades in the forward stages 130 to either the rotatable shaft 125 or a motor 310.

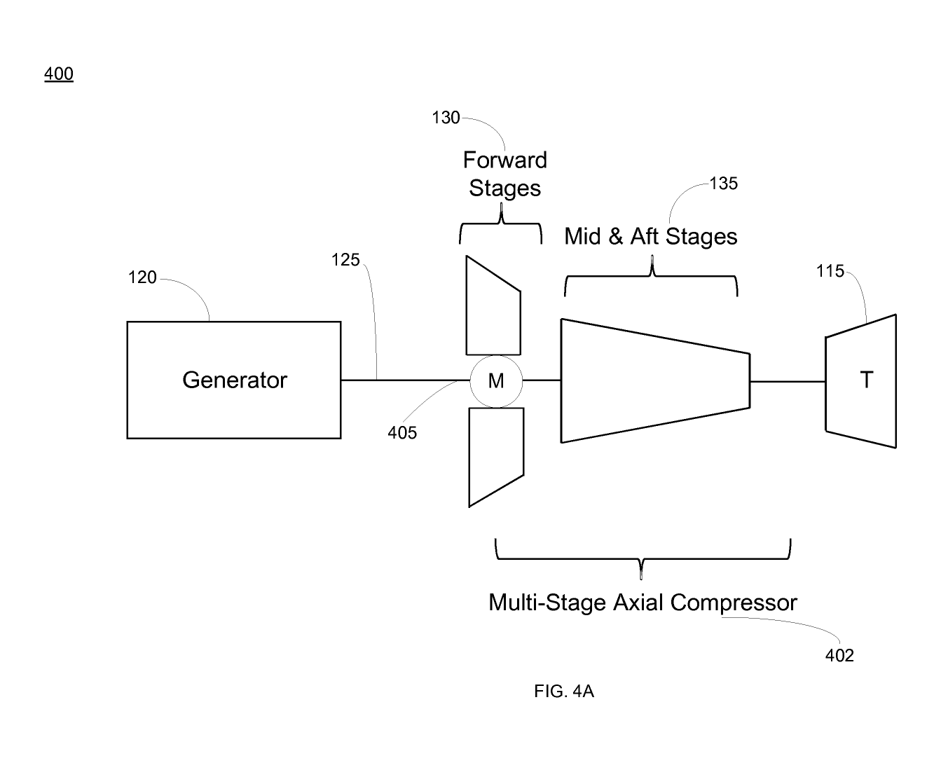

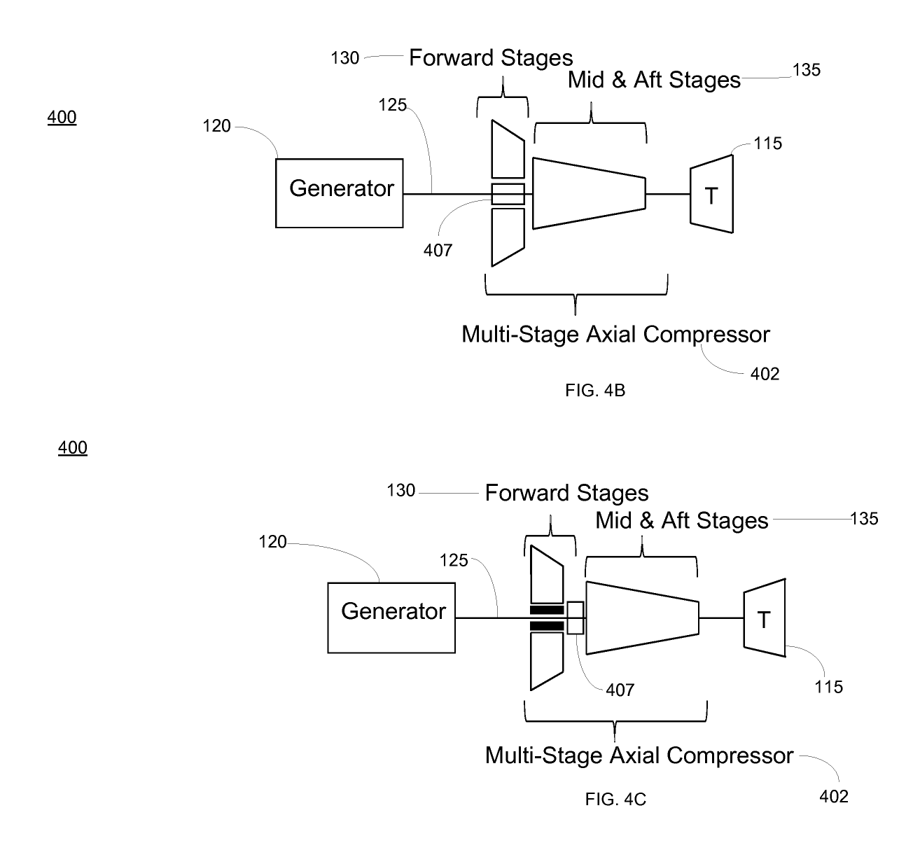

FIGS. 4A-4C are schematic diagrams of a gas turbine engine and generator arrangement 400 with a multi-stage axial compressor 402 having a motor 405 as the compressor speed reducer according to an embodiment of the present invention. In FIG. 4A, motor 405 can be located adjacent the forward stages of blades 130 on or proximate rotatable shaft 125. In this manner, the rotational speed of the moving blades in the forward stages of blades 130 is slowed down in relation to the rotating speed of the shaft 125 that turns the moving blades in the mid and aft stages 135. In one embodiment, motor 405 can include an electric motor that drives the moving blades in the forward stages 130 to rotate at a slower speed. In another embodiment, motor 405 can include a magnetic motor that drives the moving blades in the forward stages 130 to rotate at a slower speed in relation to the moving blades in the mid and aft stages 135. In one embodiment, as shown in FIG. 4B, a magnetic motor 407 can be radially aligned with the moving blades in the forward stages 130. In another embodiment, as shown in FIG. 4C, magnetic motor 407 can be axially aligned with the rotatable shaft at a location proximate in the moving blades in the forward stages 130.

As described herein, the various embodiments of the present invention describe a multi-stage axial compressor arrangement that can be used to slow down the rotational speed of moving blades in the forward stages of the compressor in relation to the moving blades in the mid and aft stages of the compressor. Slowing down the rotational speed of the forward stages of blades in relation to the mid and aft stages of moving blades allows for larger forward stages that can deliver an increase in airflow through the compressor. This translates to more output from the system that the compressor operates (e.g., gas turbine engine or stand-alone compressor). This arrangement enables the use of conventional steel blades in the compressor. As a result, compressor manufacturers can increase the annulus area of moving blades in the forward stages of the compressor, resulting in an increase in overall airflow (or gas flow) rate provided by the compressor.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises,” “comprising,” “includes,” “including,” and “having,” when used in this specification, specify the presence of stated features, integers, steps, operations, elements, and/or components, but do not preclude the presence or addition of one or more other features, integers, steps, operations, elements, components, and/or groups thereof. It is further understood that the terms “front” and “back” are not intended to be limiting and are intended to be interchangeable where appropriate

While the disclosure has been particularly shown and described in conjunction with a preferred embodiment thereof, it will be appreciated that variations and modifications will occur to those skilled in the art. Therefore, it is to be understood that the appended claims are intended to cover all such modifications and changes as fall within the true spirit of the disclosure.

What is claimed is:

1. A multi-stage axial compressor, comprising:
a rotatable shaft having rotating blades arranged in a circumferential array to define a plurality of moving blade rows each extending radially outward from the rotatable shaft;
a casing surrounding the rotatable shaft, the casing having a plurality of annular rows of stationary vanes each extending radially inward towards the rotatable shaft, the annular rows of stationary vanes arranged with the plurality of moving blade rows in an alternating pattern along an axial direction parallel with an axis of rotation of the rotatable shaft, wherein each moving blade row immediately followed by a row of stationary vanes forms a stage in the axial direction, the alternating pattern of a moving blade row immediately followed by a row of stationary vanes defines forward stages at one end of the axial direction and aft stages at an opposing end, with mid stages disposed therebetween; and
a compressor speed reducer configured to rotate the moving blades in the forward stages at a slower rotational speed than the moving blades in the mid stages and the aft stages.

2. The compressor according to claim 1, wherein the forward stages of moving blades includes the moving blades in any stage or combination of stages from a first stage up to a fifth stage as defined from the one end of the axial direction.

3. The compressor according to claim 1, wherein the compressor speed reducer is configured to rotate the moving blades in the forward stages in a direction that is opposite a direction of rotation of the mid stages and aft stages.

4. The compressor according to claim 1, wherein the compressor speed reducer is configured to rotate the moving blades in the forward stages in the same direction as the mid stages and aft stages.

5. The compressor according to claim 1, wherein the compressor speed reducer includes a fixed-axis gear system that couples the moving blades in the forward stages to the rotatable shaft.

6. The compressor according to claim 1, wherein the compressor speed reducer includes a planetary gear system that couples the moving blades in the forward stages to the rotatable shaft.

7. The compressor according to claim 1, wherein the compressor speed reducer includes a torque converter that couples the moving blades in the forward stages to the rotatable shaft.

8. The compressor according to claim 1, wherein the compressor speed reducer includes an electric motor that drives the moving blades in the forward stages.

9. The compressor according to claim 1, wherein the compressor speed reducer includes a magnetic motor that drives the moving blades in the forward stages.

10. The compressor according to claim 9, wherein the magnetic motor is radially aligned with the moving blades in the forward stages.

11. The compressor according to claim 9, wherein the magnetic motor is axially aligned with the rotatable shaft at a location proximate the moving blades in the forward stages.

12. The compressor according to claim 1, further including a bearing arrangement that is configured to support the compressor speed reducer in relation to the rotatable shaft and the moving blades in the forward stages.

13. The compressor according to claim 12, wherein the bearing arrangement includes film-type bearings.

14. The compressor according to claim 12, wherein the bearing arrangement includes rolling-element bearings.

15. The compressor according to claim 12, wherein the bearing arrangement includes magnetic bearings.

16. A gas turbine engine and generator arrangement, comprising:
a turbine;
a generator; and
a compressor in cooperative operation with the turbine and the generator, the compressor having a rotatable shaft with a plurality of moving blade rows each extending radially outward from the rotatable shaft, a plurality of annular rows of stationary vanes each extending radially inward towards the rotatable shaft, the annular rows of stationary vanes arranged with the plurality of moving blade rows in an alternating pattern along an axial direction parallel with an axis of rotation of the rotatable shaft, wherein each moving blade row immediately followed by a row of stationary vanes forms a stage in the axial direction, the alternating pattern of a moving blade row immediately followed by a row of stationary vanes defining forward stages at one end of the axial direction and aft stages at an opposing end, with mid stages disposed therebetween; and a compressor speed reducer configured to rotate the moving blades in the forward stages at a slower rotational speed than the moving blades in the mid stages and aft stages.

17. The gas turbine engine according to claim 16, wherein the compressor is a multi-stage axial flow compressor.

18. The gas turbine engine according to claim 16, wherein the compressor is a multi-stage centrifugal/compressor.

19. The gas turbine engine according to claim 16, wherein the turbine, the generator and the compressor are coupled along a single shaft.

20. The gas turbine engine according to claim 16, wherein the turbine, the generator and the compressor are coupled in a multi-shaft arrangement.
